(19) United States
(12) Patent Application Publication
(10) Pub. No.: US 2014/0061226 A1
(43) Pub. Date: Mar. 6, 2014

(54) VENDING MACHINE WITH MERCHANDISE SUPPORT RAIL

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: Yun-Lung Chen, New Taipei (TW); Mao-Lin Xu, Wuhan (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/902,954

(22) Filed: May 27, 2013

(30) Foreign Application Priority Data
Sep. 3, 2012 (CN) 2012103210534

(51) Int. Cl. G07F 11/24

(52) U.S. Cl. CPC G07F 11/24
USPC 221/277; 221/282

(57) ABSTRACT

A vending machine has a base, a securing member, and a rail for supporting merchandise as a motor-driven coil rotates to push out merchandise. The rail is supported at the motor-driven end of the coil by a single screw from which the rail can be simply lifted and pulled away, and supported at the other end of the coil by a spring-loaded clip, enabling rapid assembly and disassembly of the rail without demounting any other component of the vending machine.

### BACKGROUND

1. Technical Field

The present disclosure relates to vending machines, and particularly to a vending machine with a merchandise support rail.

2. Description of Related Art

In vending machines, a number of items of merchandise are placed on a support rail, and the support rail guides the number of merchandise to move out. However, the support rail is generally secured with screws, which is laborious and time consuming to assembly or disassemble. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a vending machine.

FIG. 2 shows an isometric view of a support rail of the vending machine of FIG. 1.

FIG. 3 is an assembled, isometric view of the vending machine of FIG. 1.

FIG. 4 is similar to FIG. 3, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

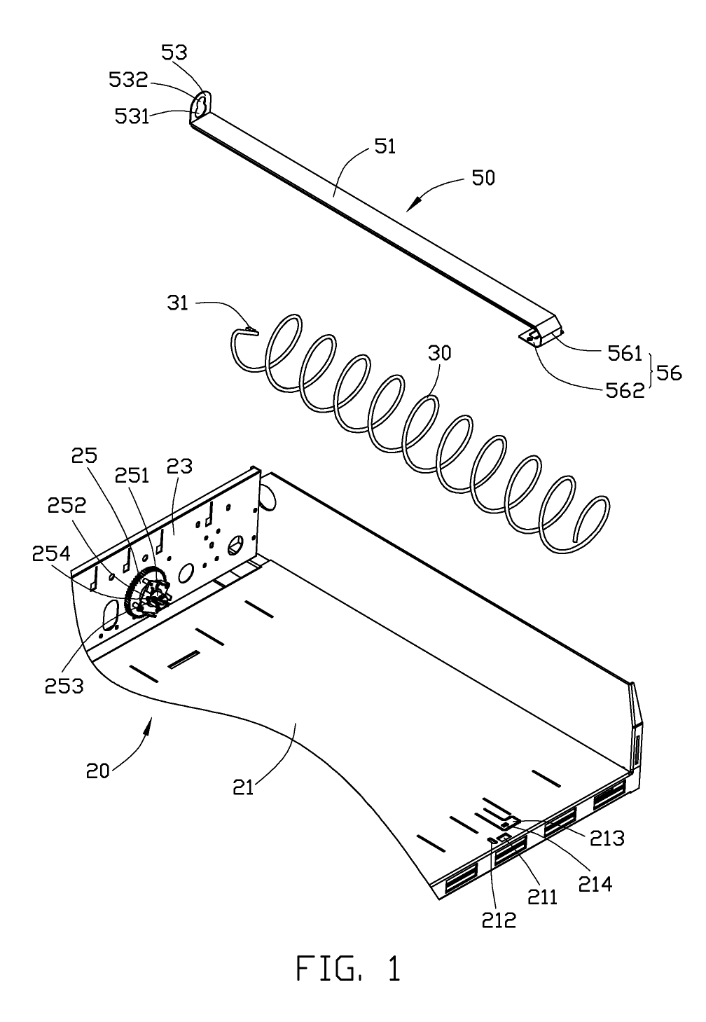

FIG. 1 shows one embodiment of a vending machine. The vending machine includes a base 20, a rigid coil 30 for moving goods, and a support rail 50.

The base 20 includes a bottom plate 21 and a securing plate 23 secured to a first end of the bottom plate 21. The securing plate 23 can be substantially perpendicular to the bottom plate 21. A second end of the bottom plate 21 defines an opening 211 and a guiding slot 212. A resilient piece 213 is located adjacent to the second end of the bottom plate 21. The opening 211 is located between the guiding slot 212 and the resilient piece 213. The resilient piece 213 defines a limiting hole 214.

A securing member 25 is rotatably mounted on the securing plate 23 and located in the base 20. The securing member 25 is rotatable relative to the securing plate 23 under an action of a driving motor (not shown). The securing member 25 includes a connecting portion 251 and a securing piece 252 beside the connecting portion 251. The connecting portion 251 defines a connecting slot 253. The securing piece 252 defines a cutout 254 opposite to the connecting slot 253. In one embodiment, the connecting portion 251 is cylindrical.

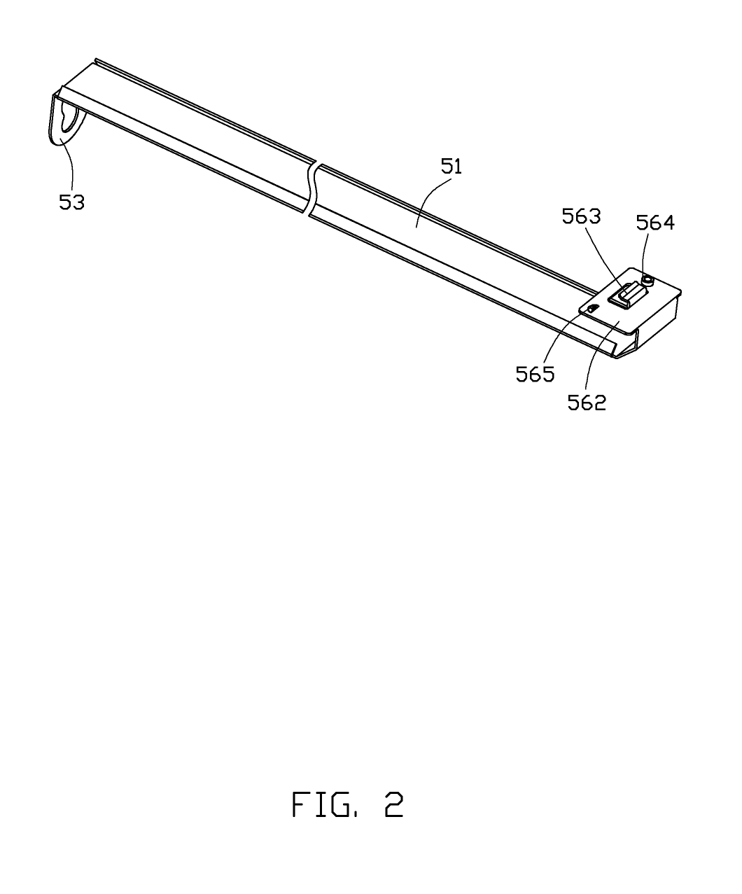

Referring to FIG. 1 and FIG. 2, the support rail 50 includes a support plate 51, a first mounting portion 53 extending from a first end of the support plate 51, and a second mounting portion 56 extending from a second end of the support plate 51. The first end of the support plate 51 is opposite to the second end of the support plate 51. The first mounting portion 53 defines an inserting hole 531 and a receiving hole 532 communicating with the inserting hole 531. In one embodiment, each of the receiving hole 532 and the inserting hole 531 is circular. The inserting hole 531 is larger than the receiving hole 532 and located under the receiving hole 532. A diameter of the receiving hole 532 is substantially equal to a diameter of the connecting portion 251.

The second mounting portion 56 includes a connecting piece 561 extending from the support plate 51 and a latching piece 562 extending from the connecting piece 561. The connecting piece 561 is elastically deformable and substantially perpendicular to the support plate 51. A hook 563 extends from the latching piece 562 corresponding to the opening 211. A guiding post 564 extends from the latching piece 562 corresponding to the guiding slot 212. A protrusion 565 extends from the latching piece 562 corresponding to the limiting hole 214. The guiding post 564 and the protrusion 565 are located on opposite sides of the hook 563.

The rigid coil 30 includes a securing end 31.

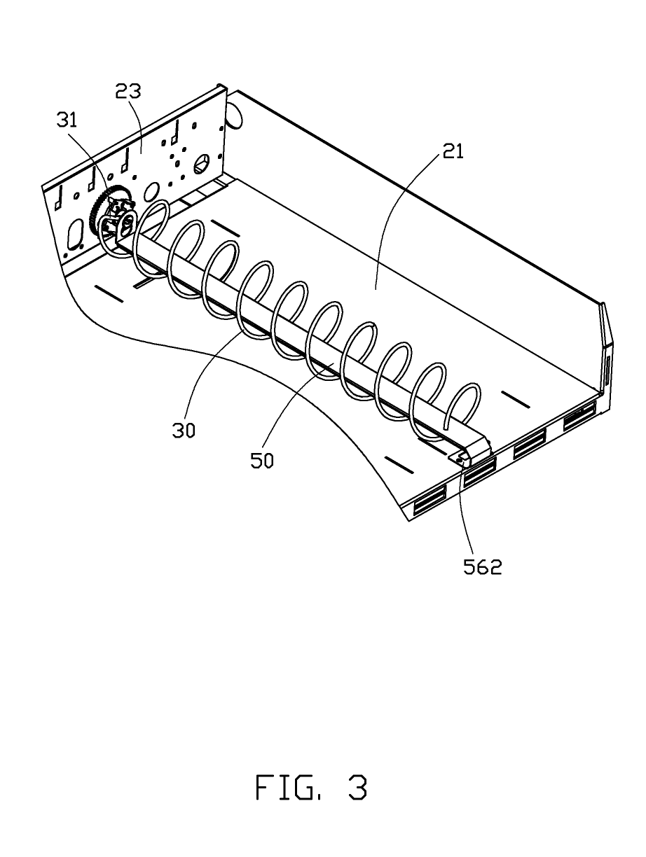

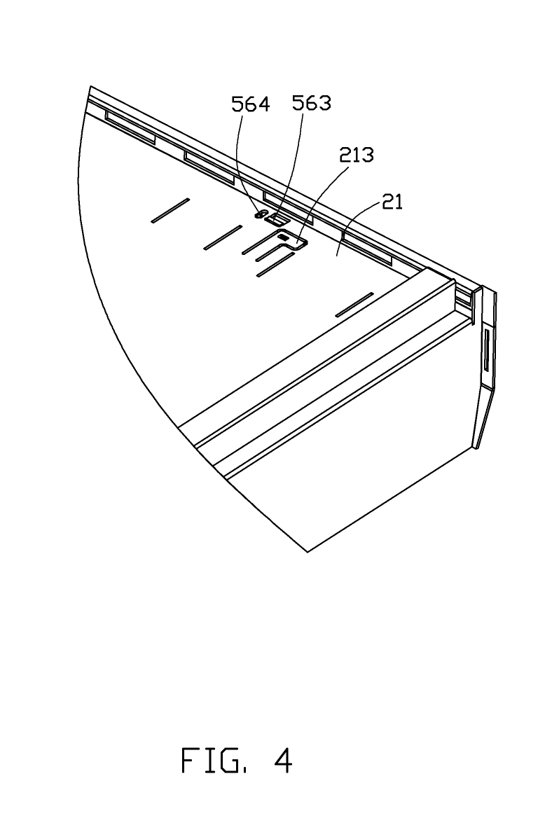

FIGS. 1-4 show that, in assembly, the securing end 31 is inserted into the connecting slot 253 and engaged in the cutout 254. The rigid coil 30 is spiraled around the support rail 50, the hook 563 is aligned with the opening 211, and the guiding post 564 is aligned with the guiding slot 212. The support rail 50 is moved towards the bottom plate 21 until the hook 563 is engaged in the opening 211, and the guiding post 564 is engaged in the guiding slot 212. In this position, the protrusion 565 abuts and elastically deforms the resilient piece 213. The support rail 50 is moved towards the securing plate 23, and the guiding post 564 slides in the guiding slot 212. When the protrusion 565 is aligned with the limiting hole 214, the resilient piece 213 rebounds to engage the protrusion 565 in the limiting hole 214, and the hook 563 is engaged with the bottom plate 21. Thus, the second mounting portion 56 is secured to the bottom plate 21.

The connecting portion 251 is inserted in the inserting hole 531. The first end of the support rail 50 is moved downwardly, and the connecting portion 251 is then engaged in the receiving hole 532. The connecting portion 251 is rotatable in the receiving hole 532. Thus, the first mounting portion 53 is secured to the securing member 25.

In disassembly, the first end of the support rail 50 is moved away from the bottom plate 21, and then the connecting portion 251 is slid into the inserting hole 531 from the receiving hole 532. The first mounting portion 53 can then be removed from the inserting hole 53. The resilient piece 213 is elastically deformed to disengage the protrusion 565 from the limiting hole 214. The support rail 50 is moved away from the securing plate 23 until the hook 563 is aligned with the opening 211. Thus, the second mounting portion 56 can be removed from the bottom plate 21.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A vending machine, comprising:
a base comprising a bottom plate and a securing plate secured to the bottom plate;
a securing member secured to the securing plate and comprising a connecting portion; and
a support rail comprising a support plate and a first mounting portion extending from a first end of the support plate;
wherein the support plate is adapted for supporting merchandise; the first mounting portion defines an inserting hole and a receiving hole communicating with the inserting hole, and the inserting hole is greater than the receiving hole; and the connecting portion is engaged in the receiving hole through the inserting hole and secures the first mounting portion to the connecting portion.

2. The vending machine of claim 1, wherein each of the receiving hole and the inserting hole is circular, and the connecting portion is cylindrical; a diameter of the inserting hole is greater than a diameter of the connecting portion; and a diameter of the receiving hole is substantially equal to the diameter of the connecting portion.

3. The vending machine of claim 1, further comprising a rigid coil for moving the merchandise, wherein the connecting portion defines a connecting slot; the securing member further comprises a securing piece beside the connecting portion, and the securing piece defines a cutout opposite to the connecting slot; and the rigid coil comprises a securing end, and the securing end is inserted in the connecting slot and engaged in the cutout.

4. The vending machine of claim 1, wherein the support rail further comprises a second mounting portion and a hook extending from the second mounting portion, the bottom plate define an opening, and the hook is engaged with the bottom plate through the opening.

5. The vending machine of claim 4, wherein the support rail further comprises a protrusion extending from the second mounting portion; a resilient piece extending from the bottom plate, and the resilient piece defines a limiting hole; and the protrusion is received in the limiting hole.

6. The vending machine of claim 5, wherein the support rail further comprises a guiding post extending from the second mounting portion, the bottom plate defines a guiding slot, and the guiding post is slidably received in the guiding slot.

7. The vending machine of claim 6, wherein the second mounting portion comprises a connecting piece extending from the support plate and a latching piece extending from the connecting piece; the connecting piece is elastically deformable and substantially parallel to the support plate; and the hook, the protrusion, and the guiding post extend from the latching piece.

8. The vending machine of claim 6, wherein the guiding slot and the resilient piece are located on opposite sides of the opening; and the protrusion and the guiding post are located on opposite sides of the hook.

9. The vending machine of claim 4, wherein the second mounting portion extends from a second end of the support plate, and the first end of the support plate is opposite to the second end of the support plate.

10. A vending machine, comprising:
a base comprising a bottom plate and a securing plate secured to the bottom plate;
a securing member secured to the securing plate and comprising a connecting portion and a securing piece beside the connecting portion;
a support rail comprising a support plate and a first mounting portion extending from a first end of the support plate; and
a rigid coil spiraled around the support plate;
wherein the support plate is adapted for supporting merchandise, and the rigid coil is adapted for moving the merchandise; the connecting portion defines a connecting slot, and the securing piece defines a cutout opposite to the connecting slot; the rigid coil comprises a securing end, and the securing end is inserted in the connecting slot and engaged in the cutout; the first mounting portion defines an inserting hole and a receiving hole communicating with the inserting hole, and the inserting hole is greater than the receiving hole; and the connecting portion is engaged in the receiving hole through the inserting hole and secures the first mounting portion to the connecting portion.

11. The vending machine of claim 10, wherein each of the receiving hole and the inserting hole is circular, and the connecting portion is cylindrical; a diameter of the inserting hole is greater than a diameter of the connecting portion; and a diameter of the receiving hole is substantially equal to the diameter of the connecting portion.

12. The vending machine of claim 10, wherein the support rail further comprises a second mounting portion and a hook extending from the second mounting portion, the bottom plate define an opening, and the hook is engaged with the bottom plate through the opening.

13. The vending machine of claim 12, wherein the support rail further comprises a protrusion extending from the second mounting portion; a resilient piece extending from the bottom plate, and the resilient piece defines a limiting hole; and the protrusion is received in the limiting hole.

14. The vending machine of claim 13, wherein the support rail further comprises a guiding post extending from the second mounting portion, the bottom plate defines a guiding slot, and the guiding post is slidably received in the guiding slot.

15. The vending machine of claim 14, wherein the second mounting portion comprises a connecting piece extending from the support plate and a latching piece extending from the connecting piece; the connecting piece is elastically deformable and substantially parallel to the support plate; and the hook, the protrusion, and the guiding post extend from the latching piece.

16. The vending machine of claim 14, wherein the guiding slot and the resilient piece are located on opposite sides of the opening; and the protrusion and the guiding post are located on opposite sides of the hook.

17. The vending machine of claim 12, wherein the second mounting portion extends from a second end of the support plate, and the first end of the support plate is opposite to the second end of the support plate.
